(19) United States
(12) Patent Application Publication
(10) Pub. No.: US 2025/0149193 A1
(43) Pub. Date: May 8, 2025

(54) GADOLINIUM OXIDE NANO PARTICLES IN COOLANT FOR REACTIVITY CONTROL

(71) Applicant: Westinghouse Electric Company LLC, Cranberry Township, PA (US)

(72) Inventor: Edward J. Lahoda, Edgewood, PA (US)

(73) Assignee: Westinghouse Electric Company LLC, Cranberry Township, PA (US)

(21) Appl. No.: 18/503,915

(22) Filed: Nov. 7, 2023

(51) Int. Cl. G21C 7/22; G21C 7/24

(52) U.S. Cl. CPC G21C 7/22; G21C 7/24

(57) ABSTRACT

A method for controlling reactivity in a nuclear reactor is provided. The method comprises circulating coolant through the nuclear reactor. A composition of the coolant comprises water and gadolinium. The gadolinium is present in the coolant at a concentration suitable for controlling a neutronic reactivity of the nuclear reactor. A method for adjusting reactivity in a nuclear reactor and a coolant composition for a nuclear reactor are also provided.

### BACKGROUND

Conventional nuclear reactors, such as pressurized water reactors, employ water-based liquid coolant compositions in a primary loop to transfer heat away from a reactor core to a secondary system. These liquid coolant compositions may employ boric acid as a neutron absorber to control reactivity. However, the addition of boric acid into a coolant composition can have undesirable secondary effects such as corrosion of primary loop material and/or fuel cladding materials, and/or generation of tritium upon absorbing neutrons, thereby increasing the risk of discharging radioactive species from the nuclear reactor. Therefore, a need exists to develop alternative coolant compositions and reactivity control methods therewith to optimize the reliability and safety of nuclear reactor operation.

### SUMMARY

The following summary is provided to facilitate an understanding of some of the innovative features unique to the aspects disclosed herein and is not intended to be a full description. A full appreciation of the various aspects disclosed herein can be gained by taking the entire specification, claims, and abstract as a whole.

In various aspects, a coolant composition for a nuclear reactor is disclosed. In some aspects, the coolant composition includes water and gadolinium. In some aspects, the gadolinium is present at a mass fraction of 150 parts per million or less based on the total weight of the coolant composition.

In various aspects, a method for controlling reactivity in a nuclear reactor is disclosed. In some aspects, the method includes circulating coolant through the nuclear reactor. In some aspects, a composition of the coolant includes water and gadolinium. In some aspects, the gadolinium is present in the coolant at a concentration suitable for controlling a neutronic reactivity of the nuclear reactor.

In various aspects, a method for adjusting reactivity in a nuclear reactor is disclosed. In some aspects, the method includes increasing an amount of gadolinium particles in a primary coolant of the nuclear reactor, decreasing the amount of gadolinium particles in the primary coolant of the nuclear reactor, or a combination thereof.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of any of the aspects disclosed herein.

### BRIEF DESCRIPTION OF THE DRAWINGS

The various aspects described herein, together with objects and advantages thereof, may best be understood by reference to the following description, taken in conjunction with the accompanying drawings as follows.

FIG. 1 illustrates a cross-sectional elevation view of a pressurized water reactor fuel assembly, according to at least one non-limiting aspect of the present disclosure.

Corresponding reference characters indicate corresponding parts throughout the several views. The exemplifications set out herein illustrate various aspects of the present disclosure, in one form, and such exemplifications are not to be construed as limiting the scope of any of the aspects disclosed herein.

### DETAILED DESCRIPTION

Certain exemplary aspects of the present disclosure will now be described to provide an overall understanding of the principles of the composition, function, manufacture, and use of the compositions and methods disclosed herein. An example or examples of these aspects are illustrated in the accompanying drawing. Those of ordinary skill in the art will understand that the compositions, articles, and methods specifically described herein and illustrated in the accompanying drawing are non-limiting exemplary aspects and that the scope of the various examples of the present disclosure is defined solely by the claims. The features illustrated or described in connection with one exemplary aspect may be combined with the features of other aspects. Such modifications and variations are intended to be included within the scope of the present disclosure.

Reference throughout the specification to “various examples,” “some examples,” “one example,” “an example,” or the like, means that a particular feature, structure, or characteristic described in connection with the example is included in an example. Thus, appearances of the phrases “in various examples,” “in some examples,” “in one example,” “in an example,” or the like, in places throughout the specification are not necessarily all referring to the same example. Furthermore, the particular features, structures, or characteristics may be combined in any suitable manner in an example or examples. Thus, the particular features, structures, or characteristics illustrated or described in connection with one example may be combined, in whole or in part, with the features, structures, or characteristics of another example or other examples without limitation. Such modifications and variations are intended to be included within the scope of the present examples.

In the following description, like reference characters designate like or corresponding parts throughout the several views of the drawings. Also in the following description, it is to be understood that such terms as “forward,” “rearward,” “left,” “right,” “above,” “below,” “upwardly,” “downwardly,” and the like are words of convenience and are not to be construed as limiting terms.

In a fuel assembly of a nuclear reactor core, fissile fuels such as, for example, uranium-235 (sometimes referred to hereinafter as “²³⁵U”) interact with an incident neutron flux and upon absorbing an appropriately energetic neutron, such as a thermal neutron, can subsequently fission into a number of lighter nuclei fission products and/or fragments, thereby generating an emission of prompt neutrons and an amount of heat. These prompt neutrons can subsequently be absorbed by other nuclei to propagate another fission event, and so on and so forth. The lifetime of a prompt neutron occurs from the time it is emitted by a fission event to the time that it is absorbed by another nuclei. In order to maximize the likelihood of continued propagation of fission events, a neutron moderator can be positioned in the reactor core to effectively slow down neutrons born at high energies.

Generally, k_{eff} represents the ratio of neutrons in a generation to the number of neutrons in a previous generation be quantified as a neutron multiplication factor k_{eff}. Thus, a k_{eff} of a reactor core can be indicative of the criticality state thereof. During operation, a nuclear reactor is generally held in a critical state where k_{eff}=1 and thus, neutrons are produced and consumed in a self-propagating chain reaction. In the context of nuclear fuel, excess reactivity can be defined as any available reactivity of the nuclear fuel above which is necessary to achieve critical conditions at a given point in time. In a conventional nuclear reactor design, such as a Pressurized Water Reactor (“PWR”), a failure to manage the excess reactivity in a nuclear fuel can result in a supercritical reactor where k_{eff}>1 and the rate of neutrons produced exceeds the neutrons consumed. Thus, inadequate management of reactor conditions can result a potentially catastrophic runaway state. Accordingly, the management of excess reactivity and power distribution within a nuclear reactor is crucial in order to maintain safe operating conditions and/or economically adequate fuel cycle length.

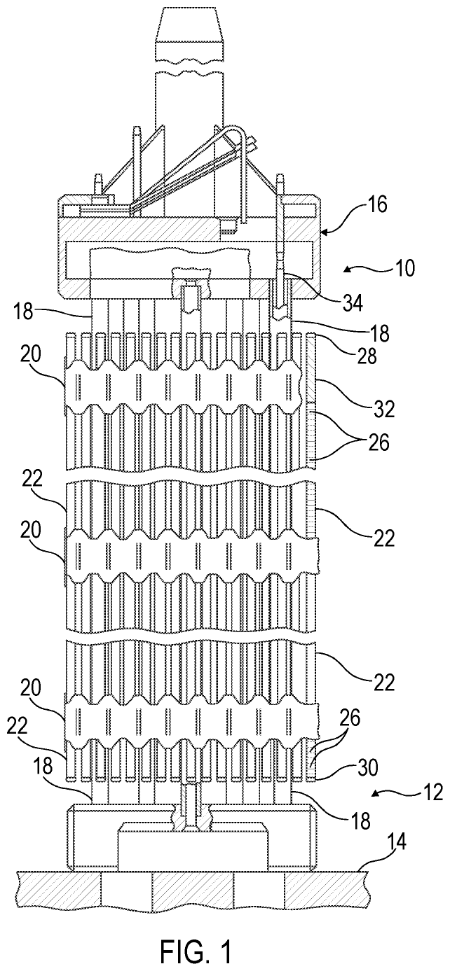

Generally, in a conventional nuclear reactor, such as a PWR, the reactor core can include a large number of fuel assemblies, each of which includes a plurality of elongated fuel elements or fuel rods. For example, FIG. 1 illustrates a cross-sectional elevation view of a fuel assembly 10, according to at least one non-limiting aspect of this disclosure. The fuel assembly 10 includes an organized array of elongated fuel rods 22. The fuel rods 22 can house a plurality of fuel pellets 26 each comprising a fissile material capable of sustaining a nuclear fission chain reaction, such as an enriched uranium-based material. The fuel pellets 26 are housed within an elongated cladding tube that is closed at opposite ends by an upper end plug 28 and a lower end plug 30. The pellets 26 may be maintained in a stack by a plenum spring 32 disposed between the upper end plug 28 and the top of the pellet stack.

Still referring to FIG. 1, the fuel rods 22 may be supported by one or more transverse grids 20 which attach to guide thimbles 18. The guide thimbles 18 extend longitudinally between top nozzle 16 and bottom nozzle 12 and are configured for discrete elongated control rods 34 to operably move therethrough. Opposite ends of the guide thimbles 18 can attach to the top nozzle 16 and bottom nozzle 12, respectively. The bottom nozzle 12 can be configured to support the fuel assembly 10 on a reactor vessel lower core plate 14 in the core region of a reactor. A liquid coolant, such as a solution of water and boric acid, may be pumped to the fuel assembly 10 upwardly through a plurality of flow openings in the lower core plate 14. The bottom nozzle 12 of the fuel assembly 10 may pass the coolant flow to and along the fuel rods 22 of the fuel assembly 10 in order to extract heat generated as a result of the fission reactions occurring therein.

A reactivity control system can compensate for changes in excess reactivity over the lifetime of a fuel assembly. For example, each of the displaceable control rods 34 can comprise a neutron absorbing material, such as, for example, boron carbide, and the insertion depth thereof can be varied by a rod control system. The concentration of a dissolved neutron absorbing material, such as boric acid, in the liquid coolant and the flow rate thereof throughout the entire reactor core can be varied by a chemical and volume control system (“CVCS”), thereby facilitating management of power distribution in the reactor vessel. Additional details are described in U.S. Pat. No. 11,430,578, entitled SUBCRITICAL REACTIVITY MONITOR UTILIZING PROMPT SELF-POWERED IN-CORE DETECTORS, which was filed on Apr. 16, 2020, and which is hereby incorporated by reference herein in its entirety.

A conventional coolant composition may contain up to 1500 ppm of a soluble form of Boron-10 (B-10), such as boric acid, as required to maintain a steady state of reactivity. However, as B-10 absorbs neutrons, tritium radioisotopes are produced through a Lithium-6 intermediate, thereby necessitating coolant remediation to reduce radionuclide discharges from the reactor.

The pH of the liquid coolant is generally controlled by the addition of other constituents. A coolant comprising boric acid generally comprises a small amount of lithium hydroxide, such as a concentration of 2-7 parts per million (“ppm”) Lithium-7 by weight, to compensate for boric acid, thereby maintaining a pH that will minimize corrosion of the reactor primary loop components. For example, plant requirements may dictate maintaining a pH between 7.1 and 7.3. However, Lithium-7 is scarce, costly and a known contributor to corrosion of zirconium claddings. Thus, Lithium-7 must be added to coolant sparingly. While potassium hydroxide has been considered as an alternative to lithium-based pH controllers, the use of potassium hydroxide in coolant can increase crud deposition and overheating therefrom at high heat flux portions of fuel within the reactor.

In order to make timely and precise adjustments of neutron absorbing elements, reactivity control systems may rely on dedicated drive mechanisms and/or pumping systems to manipulate the neutron absorbing components. Additionally, making abrupt changes to a boric acid concentration in liquid coolant circulating throughout a reactor core may require dilution by replacing a large volume of preexisting coolant in the reactor core. For example, a boric acid concentration may be lowered by replacing/diluting a portion of the coolant volume with fresh water and/or raised by adding a volume of more concentrated coolant. While boric acid may be removed from water by a separation process, such as a distillation, the time scale thereof would not be appropriate for making online changes to a circulating coolant composition.

Further to the above, commercial nuclear reactor operators are required to ensure that the reactor remains shut down by a minimum margin as defined by plant technical specifications. The amount of reactor shutdown is determined via the calculated value of k_{eff}; specifically by the amount that k_{eff} is less than 1.0, defined as the Shutdown Margin. One current methodology for the calculation of k_{eff} requires a number of conservative measures be included in the calculations to ensure the amount of boric acid added to the reactor coolant system bounds potential shutdown accident scenarios such as a control rod ejection, rapid reactor coolant system cool down, or unintentional dilution of the reactor coolant system boron concentration. The conservative amount of boric acid added to the reactor coolant system to ensure that k_{eff} remains less than the limits imposed by plant requirements must be removed again from the reactor coolant system when it is time to restart the reactor after the shutdown. If the shutdown occurs during the period at the end of an operating cycle, it can take the addition of hundreds of thousands of gallons of pure demineralized water to remove the boron added to ensure a conservative shutdown condition. Thus, a CVCS may also require a substantially constant replenishment of one or more readily accessible large liquid volumes in order to provide effective changes to a coolant composition at any given moment. Accordingly, the incorporation of conventional reactivity control systems, and boron-based coolants thereof, into a reactor design generally increases the overall footprint and/or complexity of a reactor vessel design and/or introduces complexities into the operating methods thereof.

The present disclosure provides coolant compositions for a nuclear reactor based on Gadolinium and methods for controlling and/or adjusting reactivity in a nuclear reactor which can mitigate the problems associated with currently available CVCSs and primary coolant compositions.

The coolant composition according to the present disclosure comprises water and gadolinium. The gadolinium is present in the coolant composition at a mass fraction of 150 ppm or less based on the total weight of the coolant composition. The inventors of the present disclosure have determined that this mass fraction of gadolinium can provide sufficient control of neutronic reactivity in a PWR, comparable to that of 1500 ppm of soluble B-10. For example, a mass fraction of about 5 ppm gadolinium based on the total weight of the coolant composition can provide substantially the same amount of neutron absorption as about 50 ppm to 60 ppm of boron. Thus, the coolant composition according to the present disclosure can absorb neutrons without further producing tritium.

Further to the above, the coolant composition according to the present disclosure can be in a concentrated form. As used herein, the term “concentrated coolant composition” refers to coolant compositions comprising non-water constituents of a coolant composition present at greater amounts than that of a coolant composition intended for circulation throughout a nuclear reactor core. In various examples, a concentrated coolant composition includes water and gadolinium present in the concentrated coolant composition at a mass fraction of greater than 150 ppm, or about 200 ppm, or about 300 ppm, or about 400 ppm, or about 500 ppm, or about 600 ppm, or about 1000 ppm, or about 5000 ppm, or about 10,000 ppm based on the total weight of the coolant composition.

In various examples, the coolant composition contains gadolinium in the form of a gadolinium oxide and in some examples, contains gadolinium as Gd₂O₃. Gadolinium oxides such as Gd₂O₃ are substantially insoluble in water and thus, do not contribute any substantial amount of acidity or basicity to an aqueous composition, such as the coolant of the present disclosure. For example, an amount of gadolinium ions may be present as dissolved species from gadolinium oxides in the coolant composition at limited and/or residual concentrations, such as, for example, less than 5 ppm. Accordingly, the coolant composition according to the present disclosure does not require a pH modifier such as lithium or potassium hydroxide, thereby avoiding issues related to cost and crud of conventional coolant compositions which require pH modifiers.

In certain examples, the coolant composition contains Gd₂O₃ nanoparticles in the size range of 2 to 100 nanometers (nm). Although Gd₂O₃ is substantially insoluble in water, nanoparticles thereof in this size range can remain suspended in the coolant composition without any stabilizers and/or solubilizers.

In examples of the coolant composition where the gadolinium is in the form of insoluble nanoparticles, the amount of gadolinium present in the coolant composition can be decreased via a filtration method, such as nanofiltration. Thus, a reduction in a neutron absorbing capacity of the coolant composition can be effected immediately without requiring a separate volume of liquid to replace a liquid coolant volume that is already in place within a nuclear reactor core.

Alternatively, or in addition to the above, the amount of gadolinium present in the coolant composition can be decreased via magnetic filtration. Since gadolinium-10 exhibits paramagnetic behavior due to unpaired electrons thereof, insoluble gadolinium-based nanoparticles can be magnetized by an externally applied magnetic field. Accordingly, a specific attraction between gadolinium-based nanoparticles and a magnetic filtration element can be induced as necessary to remove and/or add to the amount of gadolinium present in the coolant composition. Any remaining residual amounts of gadolinium, such as gadolinium present at 5 ppm or below which may be dissolved in the coolant composition, can be manipulated by finer separation methods, such as, for example, ion exchange or other absorption techniques.

The present disclosure also provides a method for controlling reactivity in a nuclear reactor. The method for controlling reactivity according to the present disclosure includes circulating coolant comprising water and gadolinium through the nuclear reactor. The coolant can have a composition similar to other coolant compositions described elsewhere in the present disclosure. In various examples, the gadolinium is present in the coolant at a concentration suitable for controlling a neutronic reactivity of the nuclear reactor. For example, gadolinium can be present at a concentration of 150 PPM or less based on the total weight of the coolant circulating through the nuclear reactor. In some examples, the gadolinium may be present as a water insoluble gadolinium oxide such as Gd₂O₃ and may be in a nanoparticle form. In certain examples, the gadolinium may be present as water insoluble gadolinium oxide-based nanoparticles having a diameter in the range of 2 nanometers to 100 nanometers. Thus, the method according to the present disclosure can avoid having to add stabilizers and other modifiers, thereby avoiding issues associated therewith. Other configurations of the method are contemplated by the present disclosure. For example, in some implementations, the method can include circulating a PH neutral coolant composition comprising gadolinium, water and an amount of boric acid and/or lithium hydroxide.

The method according to the present disclosure can further include removing some or all of the gadolinium therefrom. In various examples, the method includes filtering the gadolinium out of the coolant composition and may include returning the filtrate into the reactor core. The filtering can be accomplished by a magnetic filtration unit wherein an external magnetic field of about 10,000 Gauss, or greater, is applied onto a coolant flowing therethrough. Alternatively, or additionally, the method can include removing gadolinium from a coolant composition through ion exchange. For example, the coolant can be directed through an ion exchanger such as an ion-exchange resin to remove residual gadolinium at concentrations at or below 5 ppm based on the weight of the coolant composition. In one example, the method includes a combination of magnetic filtration and ion exchange techniques which can provide both coarse and fine adjustments to the gadolinium content of the coolant composition.

In some examples, the method for controlling reactivity in a nuclear reactor includes removing the gadolinium from the coolant composition without removing the water from the coolant composition. In certain examples, the gadolinium is removed at a specific rate such that the gadolinium content at any given time during reactor operation corresponds to a current level of excess reactivity in the reactor. In one example, the method includes partitioning coolant flow into multiple streams comprising respective flow control valves, such as a bypass stream and one or more gadolinium removal streams, downstream of a fuel assembly, and recombining the streams thereafter upstream of the fuel assembly. A method incorporating this configuration can redirect coolant flow through a desired stream gadolinium removal stream while maintaining a failsafe in the bypass stream, thereby providing the advantage of variable gadolinium removal rates without compromising overall coolant flow.

The method for controlling reactivity in a nuclear reactor can further include adding gadolinium to the coolant composition. The added gadolinium can be in the form of filterable gadolinium-based nanoparticle, such as water insoluble gadolinium oxide nanoparticles, and may include gadolinium that was previously filtered out of a circulating coolant composition. In some examples, adding gadolinium to the circulating coolant composition can include adding a concentrated coolant composition to the circulating coolant composition.

The present disclosure also provides a method for adjusting reactivity in a nuclear reactor. The method includes increasing an amount of gadolinium particles in a primary coolant of the nuclear reactor, decreasing the amount of gadolinium particles in the primary coolant of the nuclear reactor, or a combination thereof. The gadolinium particles are similar in many respects to other gadolinium nanoparticles disclosed elsewhere in the present disclosure. Thus, the gadolinium nanoparticles can be oxides having a diameter in the range of 2 nanometers to 100 nanometers. In various examples, decreasing the amount of gadolinium particles comprises a filtration method such as a magnetic filtration as described hereinabove.

Further to the above, the method for adjusting reactivity can include a recycling step. For example, gadolinium particles collected from decreasing the amount thereof in the primary coolant can be reintroduced into the primary coolant at a later time when a decrease in reactivity is desired.

Other configurations of a method for adjusting reactivity in a nuclear reactor are contemplated by the present disclosure. For example, in some implementations, the method can include adjusting reactivity of a nuclear reactor comprising a boron based primary coolant by increasing an amount of gadolinium particles therein and optionally, simultaneously reducing the amount of boron and lithium dissolved in the primary coolant of the nuclear reactor.

Various aspects of the present disclosure include, but are not limited to, the aspects listed in the following numbered clauses.

Clause 1—A method for controlling reactivity in a nuclear reactor. The method comprises circulating coolant through the nuclear reactor. A composition of the coolant comprises water and gadolinium. The gadolinium is present in the coolant at a concentration suitable for controlling a neutronic reactivity of the nuclear reactor.

Clause 2—The method of clause 1, wherein the gadolinium is present at a concentration of 150 parts per million or less based on the total weight of the coolant circulating through the nuclear reactor.

Clause 3—The method of any one of clauses 1 and 2, wherein the gadolinium is in the form of a gadolinium oxide.

Clause 4—The method of clause 3, wherein the gadolinium oxide is water insoluble.

Clause 5—The method of any one of clauses 1-4, wherein the composition comprises nanoparticles, the nanoparticles comprising the gadolinium.

Clause 6—The method of clause 5, wherein the nanoparticles have a diameter in the range of 2 nanometers to 100 nanometers.

Clause 7—The method of any one of clauses 1-6, the method further comprising adding a first amount of gadolinium to the coolant composition.

Clause 8—The method of clause 7, wherein the coolant composition comprises boric acid.

Clause 9—The method of any one of clauses 1-8, the method further comprising removing a second amount of gadolinium from the coolant composition.

Clause 10—The method of clause 9, wherein removing the second amount of gadolinium from the coolant composition comprises filtering the coolant composition.

Clause 11—The method of clause 10, wherein removing the second amount of gadolinium from the coolant composition comprises magnetically filtering the coolant composition

Clause 12—The method of any one of clauses 1-11, wherein removing the second amount of gadolinium from the coolant composition comprises an ion exchange process.

Clause 13—A method for adjusting reactivity in a nuclear reactor, the method comprising increasing an amount of gadolinium particles in a primary coolant of the nuclear reactor, decreasing the amount of gadolinium particles in the primary coolant of the nuclear reactor, or a combination thereof.

Clause 14—The method of clause 13, wherein the gadolinium particles are gadolinium-based nanoparticles.

Clause 15—The method of clause 14, wherein the gadolinium-based nanoparticles have a size in the range of 2 nanometers to 100 nanometers.

Clause 16—The method of any one of clauses 13-15, wherein the gadolinium particles comprise a gadolinium oxide.

Clause 17—The method of any one of clauses 13-16, wherein decreasing the amount of gadolinium comprises filtering out gadolinium particles from the primary coolant, passing the coolant through an ion exchanger, or a combination thereof.

Clause 18—The method of clause 17, wherein decreasing the amount of gadolinium comprises magnetically filtering out a portion of the amount of gadolinium from the primary coolant.

Clause 19—The method of any one of clauses 17 and 18, further comprising reintroducing the filtered-out gadolinium particles into the primary coolant.

Clause 20—A coolant composition for a nuclear reactor, the coolant composition comprising water and gadolinium, wherein the gadolinium is present at a mass fraction of 150 parts per million or less based on the total weight of the coolant composition.

Clause 21—The coolant composition of clause 20, wherein the gadolinium comprises gadolinium oxide nanoparticles.

Clause 22—The coolant composition of any one of clauses 20 and 21, wherein the gadolinium comprises soluble gadolinium.

Various features and characteristics are described in this specification to provide an understanding of the composition, structure, production, function, and/or operation of the disclosure, which includes the disclosed methods and systems. It is understood that the various features and characteristics of the disclosure described in this specification can be combined in any suitable manner, regardless of whether such features and characteristics are expressly described in combination in this specification. The Inventors and the Applicant expressly intend such combinations of features and characteristics to be included within the scope of the disclosure described in this specification. As such, the claims can be amended to recite, in any combination, any features and characteristics expressly or inherently described in, or otherwise expressly or inherently supported by, this specification. Furthermore, the Applicant reserves the right to amend the claims to affirmatively disclaim features and characteristics that may be present in the prior art, even if those features and characteristics are not expressly described in this specification. Therefore, any such amendments will not add new matter to the specification or claims and will comply with the written description, sufficiency of description, and added matter requirements.

With respect to the appended claims, those skilled in the art will appreciate that recited operations therein may generally be performed in any order. Also, although various operational flows are presented in a sequence(s), it should be understood that the various operations may be performed in other orders than those that are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

The invention(s) described in this specification can comprise, consist of, or consist essentially of the various features and characteristics described in this specification. The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. Thus, a method or system that “comprises,” “has,” “includes,” or “contains” a feature or features and/or characteristics possesses the feature or those features and/or characteristics but is not limited to possessing only the feature or those features and/or characteristics. Likewise, an element of a composition, coating, or process that “comprises,” “has,” “includes,” or “contains” the feature or features and/or characteristics possesses the feature or those features and/or characteristics but is not limited to possessing only the feature or those features and/or characteristics and may possess additional features and/or characteristics.

The grammatical articles “a,” “an,” and “the,” as used in this specification, including the claims, are intended to include “at least one” or “one or more” unless otherwise indicated. Thus, the articles are used in this specification to refer to one or more than one (i.e., to “at least one”) of the grammatical objects of the article. By way of example, “a component” means one or more components and, thus, possibly more than one component is contemplated and can be employed or used in an implementation of the described compositions, coatings, and processes. Nevertheless, it is understood that use of the terms “at least one” or “one or more” in some instances, but not others, will not result in any interpretation where failure to use the terms limits objects of the grammatical articles “a,” “an,” and “the” to just one. Further, the use of a singular noun includes the plural, and the use of a plural noun includes the singular, unless the context of the usage requires otherwise.

In this specification, unless otherwise indicated, all numerical parameters are to be understood as being prefaced and modified in all instances by the term “about,” in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described herein should at least be construed in light of the number of reported significant digits and by applying ordinary rounding techniques.

Any numerical range recited herein includes all sub-ranges subsumed within the recited range. For example, a range of “1 to 10” includes all sub-ranges between (and including) the recited minimum value of 1 and the recited maximum value of 10, that is, having a minimum value equal to or greater than 1 and a maximum value equal to or less than 10. Also, all ranges recited herein are inclusive of the end points of the recited ranges. For example, a range of “1 to 10” includes the end points 1 and 10. Any maximum numerical limitation recited in this specification is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited. All such ranges are inherently described in this specification.

As used in this specification, particularly in connection with layers, the terms “on,” “onto,” “over,” and variants thereof (e.g., “applied over,” “formed over,” “deposited over,” “provided over,” “located over,” and the like) mean applied, formed, deposited, provided, or otherwise located over a surface of a substrate but not necessarily in contact with the surface of the substrate. For example, a layer “applied over” a substrate does not preclude the presence of another layer or other layers of the same or different composition located between the applied layer and the substrate. Likewise, a second layer “applied over” a first layer does not preclude the presence of another layer or other layers of the same or different composition located between the applied second layer and the applied first layer.

Whereas particular examples of this disclosure have been described above for purposes of illustration, it will be evident to those skilled in the art that numerous variations of the details of the present disclosure may be made without departing from the disclosure as defined in the appended claims.

What is claimed is:

1. A method for controlling reactivity in a nuclear reactor, the method comprising:
circulating coolant through the nuclear reactor, wherein a composition of the coolant comprises:
water; and
gadolinium, wherein the gadolinium is present in the coolant at a concentration suitable for controlling a neutronic reactivity of the nuclear reactor.

2. The method of claim 1, wherein the gadolinium is present at a concentration of 150 parts per million or less based on the total weight of the coolant circulating through the nuclear reactor.

3. The method of claim 1, wherein the gadolinium is in the form of a gadolinium oxide.

4. The method of claim 3, wherein the gadolinium oxide is water insoluble.

5. The method of claim 3, wherein the composition comprises nanoparticles, the nanoparticles comprising the gadolinium.

6. The method of claim 5, wherein the nanoparticles have a diameter in the range of 2 nanometers to 100 nanometers.

7. The method of claim 1, the method further comprising adding a first amount of gadolinium to the coolant composition.

8. The method of claim 7, wherein the coolant composition comprises boric acid.

9. The method of claim 1, the method further comprising removing a second amount of gadolinium from the coolant composition.

10. The method of claim 9, wherein removing the second amount of gadolinium from the coolant composition comprises filtering the coolant composition.

11. The method of claim 10, wherein removing the second amount of gadolinium from the coolant composition comprises magnetically filtering the coolant composition.

12. The method of claim 9, wherein removing the second amount of gadolinium from the coolant composition comprises an ion exchange process.

13. A method for adjusting reactivity in a nuclear reactor, the method comprising:
increasing an amount of gadolinium particles in a primary coolant of the nuclear reactor;
decreasing the amount of gadolinium particles in the primary coolant of the nuclear reactor; or
a combination thereof.

14. The method of claim 13, wherein the gadolinium particles are gadolinium-based nanoparticles.

15. The method of claim 14, wherein the gadolinium-based nanoparticles have a size in the range of 2 nanometers to 100 nanometers.

16. The method of claim 13, wherein the gadolinium particles comprise a gadolinium oxide.

17. The method of claim 13, wherein decreasing the amount of gadolinium comprises filtering out gadolinium particles from the primary coolant, passing the coolant through an ion exchanger, or a combination thereof.

18. The method of claim 17, wherein decreasing the amount of gadolinium comprises magnetically filtering out a portion of the amount of gadolinium from the primary coolant.

19. The method of claim 17, further comprising reintroducing the filtered-out gadolinium particles into the primary coolant.

20. A coolant composition for a nuclear reactor, the coolant composition comprising:
water; and
gadolinium, wherein the gadolinium is present at a mass fraction of 150 parts per million or less based on the total weight of the coolant composition.

21. The coolant composition of claim 20, wherein the gadolinium comprises gadolinium oxide nanoparticles.

22. The coolant composition of claim 20, wherein the gadolinium comprises soluble gadolinium.
